(19) United States
(12) Patent Application Publication
(10) Pub. No.: US 2003/0128816 A1
(43) Pub. Date: Jul. 10, 2003

(54) Method and system for synchronizing a plurality of apparatus

(76) Inventors: Pascal Lumbroso, Sceaux (FR); Remy Klausz, Neuilly/Seine (FR); Francois Kotian, Bois d'Arcy (FR)

Correspondence Address: General Electric Company, 3135 Easton Turnpike, Fairfield, CT, 06828, US

(21) Appl. No.: 10/327,155

(22) Filed: Dec. 23, 2002

(30) Foreign Application Priority Data
Jan. 8, 2002 (FR) 02 00167

(51) Int. Cl. H05G 1/00

(52) U.S. Cl. 378/210

(57) ABSTRACT

A system comprising a plurality of apparatus, each equipped with at least one central unit including an internal clock, the internal clocks being synchronized. At least two of the apparatus receive signals and synchronize their respective internal clock with the signals. The signals can be a radio signal that can be from a satellite, such as a global positioning system. The apparatus may be an imaging apparatus or other devices used in medical technology.

### CROSS-REFERENCE TO RELATED APPLICATIONS

This application claims the benefit of a priority under 35 USC 119 to French Patent Application No. 02 00167 filed Jan. 8, 2002, the entire contents of which are hereby incorporated by reference.

### BACKGROUND OF THE INVENTION

The present invention is directed to a method and system for synchronizing a plurality of apparatus. In particular the present invention concerns synchronization of internal clocks of an apparatus used in the medical field and, in particular, in the field of imaging, e.g., X-ray, CT, ultrasound, magnetic resonance, nuclear medicine, and related and other fields where data is collected and transmitted.

EP A 0,849,980 describes an X-ray imaging apparatus using an image detector. An X-ray apparatus comprises an X-ray tube, the energy of which is provided by a power supply. The X-ray beam emitted by the tube is received by a set of X-ray detectors equipped with a scintillator and an array of photosensors. A control unit is capable of controlling the array of detectors in order to acquire an image and to read the output signal from each photosensor element. An image processing unit is connected to the control unit. The image processed can be displayed on a video monitor and can be stored in an image storage device. The general operation of the apparatus is governed by a system controller, which receives commands from the user through a man-machine interface. An exposure control circuit, connected to the controller of the system, receives an automatic exposure control signal from an array of automatic exposure control photosensors and controls the power supply of the X-ray tube.

There is a need to establish communications between this type of imaging apparatus and other imaging apparatus or computers. In general, the need is to be able to synchronize separate internal clocks of such apparatus, systems and computers in an economical manner. In any imaging system or apparatus used in the medical field, there are numerous operations, data collections, etc., that are managed by different and often independent computers that require a high level of synchronization, particularly in real time. Examples of such operations include synchronization of a detection device and an acquisition device and synchronizing data acquired with two different detectors (e.g., images and physiological data). Dedicated synchronization lines, high-speed software links or even complex synchronization protocols can secure synchronization. However, these solutions are very expensive.

### BRIEF DESCRIPTION OF THE INVENTION

The method and system, according to one aspect of the invention, comprises a plurality of apparatus, each equipped with at least one central unit including an internal clock, the internal clocks being synchronized. At least two of the apparatus include a means for receiving signals and means for synchronizing their respective internal clock with the signals.

In an embodiment of the invention, the means for receiving is capable of receiving satellite signals.

In an embodiment of the invention, the means for receiving is capable of receiving signals from a global positioning system.

In an embodiment of the invention, the means for receiving is capable of receiving signals defining a position and a date.

In an embodiment of the invention, each apparatus may comprise means for providing radiation, means for detection of the radiation, means for image acquisition means and means for detecting physiological data, each apparatus comprising means for signal reception and means for synchronization of a respective system internal clock with the means for signal reception.

An embodiment of the apparatus can include an X-ray apparatus, for example, for mammographic, conventional radiological, RAD or RF, neurological or vascular (peripheral or cardiac) use, comprising of: an X-ray tube and a collimator for forming and delimiting an X-ray beam; an image receiver, generally a radiological image intensifier and a video camera, or a solid state detector; a positioner bearing the X-ray tube and collimator assembly, on one side, and image receiver, on the other, movable in space on one or more axes; and means for positioning an object, such as a table provided with a platform intended to support the object in desired position

In an embodiment a radiology apparatus may further comprises means for control of the X-ray tube, making it possible to regulate parameters such as radiation dose, exposure time, power voltage, etc.; means for control of the different motors enabling the radiology apparatus to be moved on its different axes, as well as the means for positioning and means for image acquisition and processing to provide, if desired, a screen display and a storage of data for two- or three-dimensional images with functions such as a zoom, a translation on one or more perpendicular axes, a rotation on different axes, an image subtraction or even a contour extraction. Electronic cards capable of different adjustments provide these functions. Each electronic card or each group of electronic cards is connected to a receiver of signals, such as radio signals emitted by, for example, a global positioning (GPS) system.

The system, according to one aspect of the invention, may comprise a plurality of apparatus, each equipped with at least one central unit containing an internal clock, the internal clocks being synchronized. At least two of the apparatus may include means for receiving signals and means of synchronization of their respective internal clock with the signals.

The system, according to one aspect of the invention, may comprise apparatus, each equipped with at least one central unit containing an internal clock, the respective internal clocks being synchronized. At least two of the apparatus may include means for receiving signals and means for synchronization of their respective internal clock with the signals.

According to one aspect of the invention, a method for synchronization of the central internal clocks of a plurality of apparatus comprises stages in which at least two of the apparatus receive signals and synchronize their respective internal clock with the signals.

The signals can be provided from satellites and/or a global positioning system. The signals can define a position and a date.

An embodiment of the invention is a computer program containing program code means for applying the stages of the method, when the program is operating on a computer.

An embodiment of the invention is a support or medium capable of being read by a device for reading program code means that are stored therein and capable of applying the stages of the method, when the program is operating on a computer.

### BRIEF DESCRIPTION OF THE DRAWINGS

An embodiment of the invention is described with reference to the attached figures, in which:

FIG. 1 is a schematic view of a radiography device;

FIG. 2 is a block diagram of the device of FIG. 1;

FIG. 3 is a schematic view of a first stage;

FIG. 4 is a schematic view of a second stage;

FIG. 5 is a schematic view of an example of use of the invention; and

FIG. 6 is a schematic view of another example of use of the invention.

### DETAILED DESCRIPTION OF THE INVENTION

An embodiment of the invention, as described below, is an application of the invention to radiology, for example, an X-ray apparatus and, in particular, in the medical field to vascular X-ray imaging devices. The invention can, of course, be applied in other fields.

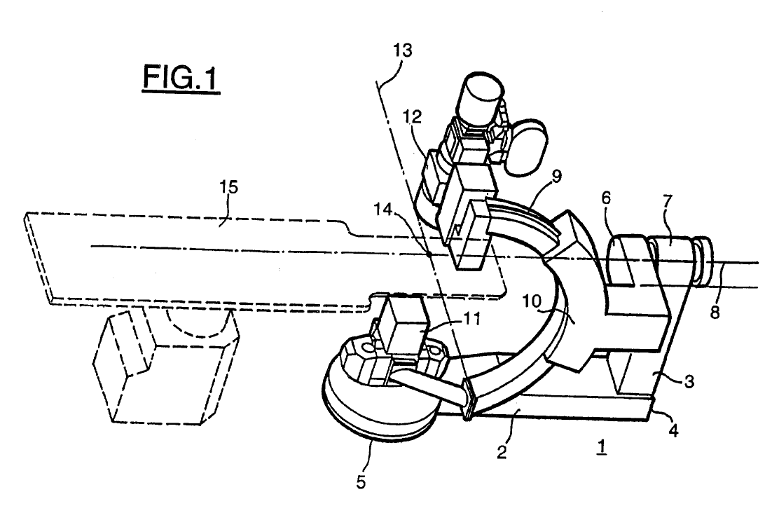

In FIG. 1, a radiology apparatus comprises an L-shaped stand 1, with a substantially horizontal base 2 and a substantially vertical support 3 fastened to an end 4 of the base 2. At the opposite end 5, the base 2 has an axis of rotation parallel to the support 3 on which the stand is capable of turning. A support arm 6 is fastened at a first end to the top 7 of the support 3 in rotation on an axis 8. The support arm 6 can be bayonet-shaped. A C-shaped circular arm 9 is held by another end 10 of the support arm 6. The C-arm 9 is capable of sliding in rotation on an axis 13 in relation to the end 10 of the support arm 6.

The C-arm 9 supports an X-ray emission means 11 and an X-ray detector 12 in diametrically opposite positions facing each other. The detector 12 has a flat detection surface. The direction of the X-ray beam is determined by a straight line joining a focal point of the emission means 11 to the center of the flat surface of the detector 12. The axis of rotation of the stand 1, the axis 8 of the support arm 6 and the axis 13 of the C-arm 9 are secant at a point 14 called isocenter. In mid-position, these three axes are perpendicular to one another. The axis of the X-ray beam also passes through point 14.

A table 15, provided to accommodate an object to be imaged, such as a patient, possesses a longitudinal orientation aligned with axis 8 in rest position. The table 15 can be displaced in translation along three perpendicular axes.

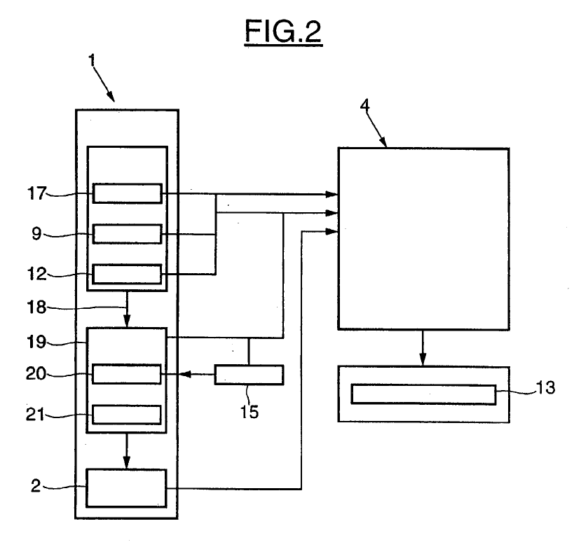

In FIG. 2, the radiology device 1 is equipped with a high-voltage generator 17 for the power supply of the X-ray source 9. The X-ray beam 18 emitted below the filter 12 undergoes an attenuation due to the object 19, such as a patient's breast, an attenuation that may be due to both the breast 20 and a contrast product 21, iodine-based, for example, injected into the breast 20. The X-ray beam then reaches the digital receiver 2, an output of which is connected to the processing and control unit 4.

In an embodiment of the invention global positioning technology, for example, the technology known as GPS, synchronizes the internal clocks of different apparatus.

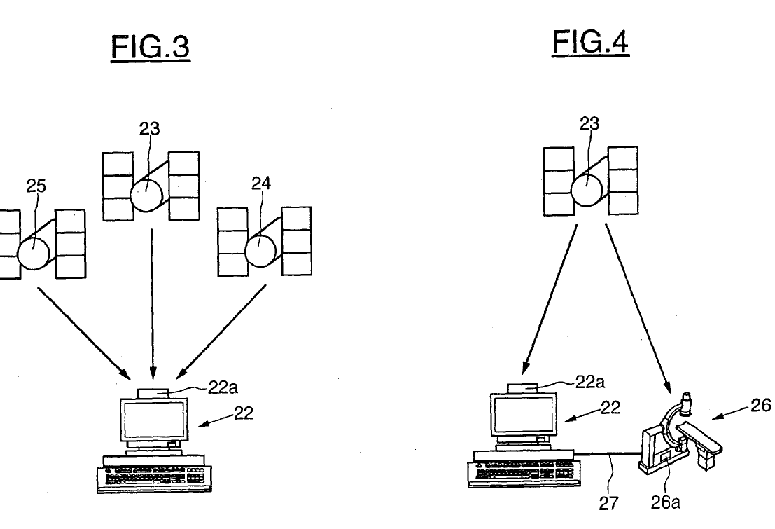

In a first stage, such as illustrated in FIG. 3, an apparatus provided with an internal clock, for example, a computer 22 is geographically located as a result of the detection carried out by three satellites 23, 24 and 25. A very precise localization and calibration can be obtained by taking an average of numerous digital acquisitions by each satellite 23 to 25. Precise localization and calibration is possible because the computer 22 is stationary in relation to the ground.

Knowing with high precision the geographic location of the apparatus 22, the same localization and calibration operation is carried out with an apparatus 26 that is represented in FIG. 4 as being a radiology apparatus. However, the apparatus 26 could be any other type of apparatus, such as a computer, a body data measuring apparatus such as an electrocardiograph machine, a scanner, etc. The computer 22 and the apparatus 26 are joined by an unsynchronized link 27. The computer 22 is provided with GPS equipment 22a enabling it to receive signals emitted by the satellites 23 to 25. The apparatus 26 is also provided with GPS equipment 26a.

The computer 22 receives time and position information from satellite 23 or from another satellite with the same application. The computer 22 can thus synchronize a standard clock or its high-precision clock with the precision required, as a function of the time reference supplied by the satellite 23 and of its position, which enables it to determine the distance covered by the signal from the satellite 23, resulting in a precise time synchronization. Apparatus 26 performs the same operations. Consequently, the computer 22 and the apparatus 26 see their internal clocks synchronized with high precision.

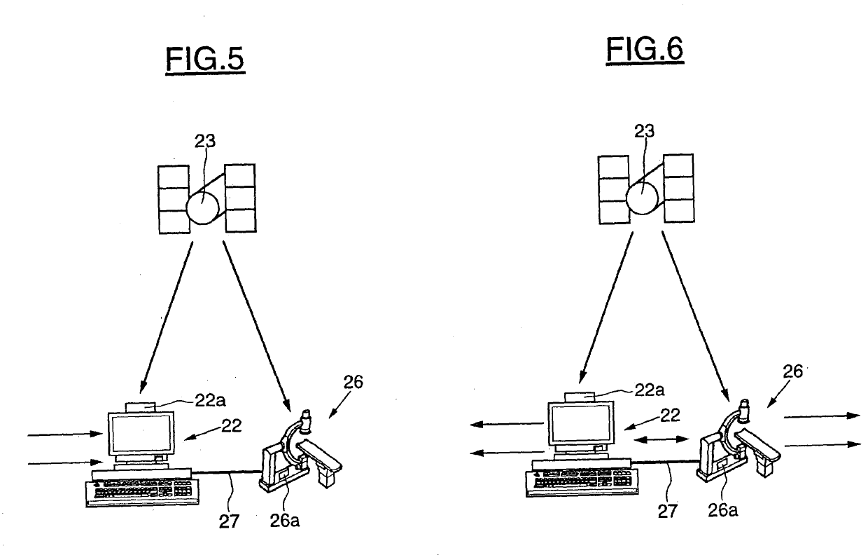

An example of application of the invention is illustrated in FIG. 5. The computer 22 receives electrophysiology data, for example, an electrocardiogram, a blood pressure reading, etc., from a blood measuring and analysis apparatus not represented. The radiology apparatus 26 generates image data that it transmits via the link 27 to the computer 22. The computer 22 makes possible a time matching of this data, since the data can be synchronized at any time and in any place, by reason of the common time referential associated with them. The time referential will, in general, be of universal type.

FIG. 6 illustrates another example of use of the invention. Before an operation such as a radiological imaging operation, the computer 22 and the radiology apparatus 26 are synchronized and one of the two apparatus 22 or 26 transmits to the other a command order including the exact date on which the other apparatus must perform an action. Then, each apparatus 22, 26 separately carry out the orchestration of its own peripherals, that is, through an internal clock, possibly of low precision, or directly through a real time output.

A first stage of preparation of the action is then distinguished, at the end of which each apparatus must be ready to carry out the action, a stage in the course of which the actions are carried out, each apparatus 22, 26 then operating independently, and a subsequent stage in which the resulting data is sent by one apparatus to the other. It can therefore be understood that it is possible to synchronize with high precision a plurality of apparatus, the total number of which can be relatively great, and to obtain synchronization output data sufficient for efficient subsequent operation. The precision obtained can be in the order of one microsecond or even less.

In an aspect of the invention not only the synchronization of apparatus are possible, but also the synchronization of output data. The invention is likewise suited to the synchronization of mobile medical systems, provided that it is inactive on transport and is used when it comes to a stop. In addition, it can be arranged for mobile medical systems to include a portion of software that compares those geographic coordinates with a predetermined geographic area and authorizes operation of the system only if the system is located in the predetermined area. This constitutes an extremely effective anti-theft means that prevents any unauthorized use.

An embodiment of the invention makes it possible for medical apparatus and systems to benefit from the precision of global positioning systems, which is in the order of a nanosecond. Asynchronous networks can therefore be used between different medical systems or apparatuses. A hemodynamic monitoring system and a radiology apparatus can be synchronized and the data resulting therefrom can be time-matched.

An embodiment of the invention, one can synchronize in real time systems requiring a high level of synchronization, such as radiological apparatus or systems equipped with several internal clocks, like, for example, a detection device and an acquisition device. One can also synchronize data acquired with two different detectors, an image detector and a physiological data detector, such as an electrocardiograph machine, for example.

One skilled in the art can or may make various modifications in structure and/or means or manner and/or way or equivalents thereof of the disclosed embodiments without departing from the scope and extent of the invention.

What is claimed is:

1. A method of synchronization of at least two apparatus comprising:
providing for each apparatus a central internal clock;
providing to each apparatus signals that determine time and position of each apparatus; and
synchronizing the internal clock of each apparatus with the signals.

2. The method of claim 1 wherein the signals are provided by a satellite.

3. The method of claim 1 wherein the signals are provided by a global positioning system.

4. A radiological imaging system comprising:
a plurality of apparatus, each provided with at least one central unit including an internal clock, the internal clocks being synchronized;
at least two of the apparatus including means for receiving signals; and
at least two of the apparatus including means for synchronizing their respective internal clock with the signals.

5. The system according to claim 5 wherein the means for receiving is capable of receiving signals from a satellite.

6. The system according to claim 5 wherein the means for receiving is capable of receiving signals from a global positioning system.

7. The system according to claims 4 wherein the means for receiving is capable of receiving signals defining a position and a date.

8. The system according to claim 4 wherein at least one of the apparatus comprises:
means for providing radiation;
means for detection of the radiation; and
means for image acquisition.

9. The system according to claim 8 wherein at least one of the apparatus comprises means for physiological data detection.

10. A computer program containing program code means for applying the method according to claim 1 when the program is operating on a computer.

11. A support capable of being read by a device for reading program code means which are stored therein and capable of applying the method according to claim 1 when the program is operating on a computer.
